(19) United States
(12) Patent Application Publication
(10) Pub. No.: US 2010/0001699 A1
(43) Pub. Date: Jan. 7, 2010

(54) OUTPUT VOLTAGE CONTROL CIRCUIT FOR MODULAR POWER SUPPLIES

(75) Inventor: Milan DRAGOJEVIC, Natick, MA (US)

Correspondence Address: Murata Power Solutions;c/o Keating & Bennett, LLP, 1800 Alexander Bell Drive, SUITE 200, Reston, VA, 20191, US

(73) Assignee: MURATA POWER SOLUTIONS, Mansfield, MA (US)

(21) Appl. No.: 12/496,600

(22) Filed: Jul. 1, 2009

Related U.S. Application Data
(60) Provisional application No. 61/077,589, filed on Jul. 2, 2008.

(51) Int. Cl. G05F 1/10

(52) U.S. Cl. 323/234

(57) ABSTRACT

A method for adjusting an output voltage of a module includes providing a digital reference voltage, converting the digital reference voltage to an analog reference voltage, comparing the output voltage and the analog reference voltage, controlling the module based upon a result of the step of comparing the output voltage and the analog reference voltage such that the output voltage corresponds to the analog reference voltage, and adjusting the digital reference voltage. An increase in the digital reference voltage causes a corresponding increase in the output voltage, and a decrease in the digital reference voltage causes a corresponding decrease in the output voltage.

### BACKGROUND OF THE INVENTION

1. Field of the Invention

The present invention relates to modular power supplies. More specifically, the present invention relates to methods and circuits for adjusting a voltage output of a modular power converter.

2. Description of the Related Art

It is known in the field of modular power supplies that it is desirable to adjust the output voltage of a power converter module to ensure that a proper output voltage is provided by the modular power converter. If the wrong output voltage is applied to a load, there is a risk of the load not functioning properly or being damaged or destroyed.

A first known method of adjusting the output voltage of a power converter uses a mechanical potentiometer in a voltage divider connected to the output voltage. The divided voltage is compared to a reference voltage. The potentiometer can be adjusted to change a voltage level of the divided voltage. By adjusting the voltage level of the divided voltage, it is possible to change the comparison of the divided voltage and the reference voltage.

However, potentiometers have a few disadvantages. First, the potentiometers include electrical contacts that slide against each other when the value of the electrical resistance of the potentiometer is adjusted. Over time, the connection between these electrical contacts becomes less and less reliable due to wear on the electrical contacts. Second, using a single turn potentiometer usually results in accuracy and drift problems. To remedy these shortcomings, multi-turn potentiometers could be used. However, multi-turn potentiometers are too expensive to justify using them in all applications.

It is known to use digital potentiometers instead of mechanical potentiometers. Digital potentiometers operate similar to mechanical potentiometers, except that they do not suffer from as many accuracy and reliability problems. However, digital potentiometers can only be adjusted through some type of software interface like I2C (IC to IC) or SPI (Serial Peripheral Interface, also known as Microwire) connected to a computer. Accordingly, it is not easy to change the resistance of digital potentiometers as with mechanical potentiometers.

A second known method of adjusting the output voltage of a power converter entails connecting a resistor with a fixed resistance to the output return or the positive output rail of a power converter. A resistor is very reliable and can be accurately tailored to a specific application. However, the only way to change the output of the power converter is to physically remove the resistor from the power converter and replace it with another resistor with a different fixed resistance. This adjustment method is very mechanically complicated and thus is not desirable in applications where the output of the power converter is adjusted frequently.

A third known method of adjusting the output voltage of a power converter uses VID (Voltage Identification). This method is used in VRM (Voltage Regulator Module) applications. In VID, the voltage output by the power converter is set with 5-, 6-, 7-, or 8-bit digital inputs. These digital inputs are then converted to analog signals that are used to set the reference voltage levels of the individual power modules. However, this method requires a plurality of digital inputs to be supplied to the power supplies to change the output voltage of the power converter. The connections between the digital inputs and the individual power modules can be difficult and complicated, and it is not convenient to change the output level of an individual power module on the fly with this method.

### SUMMARY OF THE INVENTION

To overcome the problems described above, preferred embodiments of the present invention provide methods and circuits for adjusting a voltage output of a modular power converter that are reliable, low cost, and easy to perform or implement.

A method of adjusting an output voltage of a module according to a preferred embodiment of the present invention include providing a digital reference voltage, converting the digital reference voltage to an analog reference voltage, comparing the output voltage and the analog reference voltage, controlling the module based upon a result of the step of comparing the output voltage and the analog reference voltage such that the output voltage corresponds to the analog reference voltage, and adjusting the digital reference voltage. An increase in the digital reference voltage causes a corresponding increase in the output voltage, and a decrease in the digital reference voltage causes a corresponding decrease in the output voltage.

The output voltage preferably satisfies the following equation:

Vout=k×Nadj

where Vout is the output voltage, Nadj is an integer selected during the adjusting step, and k is a constant. The voltage output is preferably connected to a voltage divider with a first resistor and a second resistor, and the constant k satisfies the following equation:

$$k = \frac{R 1 + R 2}{R 2} \times \frac{Vdd}{N max}$$

where R1 is the resistance of the first resistor, R2 is the resistance of the second resistor, Vdd is a voltage level of a voltage supply, and Nmax is an integer equal to a number of voltage divisions between a minimum voltage and a maximum voltage.

The adjusting step preferably includes a step of fine adjusting and a step of coarse adjusting. The digital reference voltage preferably includes a coarse digital reference voltage and a fine coarse digital reference voltage. The output voltage preferably satisfies the following equation:

Vout=k1×Nadjc+k2×Nadjf

where Vout is the output voltage, Nadjc is an integer selected during the coarse adjusting step, Nadjf is an integer selected during the fine adjusting step, and k1, k2 are constants. The voltage output is preferably connected to a voltage divider with a first resistor and a second resistor. The coarse digital reference voltage is preferably connected to a first RC filter including a third resistor. The fine digital reference voltage is connected to a second RC filter including a fourth resistor. The constants k1 and k2 preferably satisfy the following equations:

$$k 1 = \frac{R 1 + R 2}{R 2} \times \frac{Rf}{Rf + Rc} \times \frac{Vddc}{N max c}$$

$$k 2 = \frac{R 1 + R 2}{R 2} \times \frac{Rc}{Rf + Rc} \times \frac{Vddf}{N max f}$$

where R1 is the resistance of the first resistor, R2 is the resistance of the second resistor, Rc is the resistance of the third resistor, Rf is the resistance of the fourth resistor, Vddc is a voltage level of a coarse voltage supply, Vddf is a voltage level of a fine voltage supply, Nmaxc is an integer equal to a number of voltage divisions between a minimum coarse voltage and a maximum coarse voltage, and Nmaxf is an integer equal to a number of voltage divisions between a minimum fine voltage and a maximum fine voltage.

A method of adjusting an output voltage of a module according to another preferred embodiment of the present invention includes providing a digital reference voltage and a first analog reference voltage, converting the digital reference voltage to a second analog reference voltage, combining the second analog reference voltage and the output voltage, comparing the first analog reference voltage and the combined second analog reference voltage and output voltage, controlling the module based upon a result of the step of comparing the first analog reference voltage and the combined second analog reference voltage and output voltage so the output voltage corresponds to the second analog reference voltage, and adjusting the digital reference voltage. An increase in the digital reference voltage causes a corresponding decrease in the output voltage, and a decrease in the digital reference voltage causes a corresponding increase in the output voltage.

The output voltage preferably satisfies the following equation:

Vout=k1×Vref=k2×Nadj

where Vout is the output voltage, Vref is the first analog reference voltage, Nadj is an integer selected during the adjusting step, and k1 and k2 are constants. The voltage output is preferably connected to a voltage divider with a first resistor and a second resistor connected in series between ground and the output voltage. The second analog reference voltage is preferably connected to a node between the first resistor and the second resistor through a third resistor. The constants k1 and k2 preferably satisfy the following equations:

$$k 1 = \frac{R 1 \times R 2 + R 1 \times R 3 + R 2 \times R 3}{R 2 \times R 3}$$

$$k 2 = \frac{R 1}{R 2} \times \frac{Vdd}{N max}$$

where R1 is the resistance of the first resistor, R2 is the resistance of the second resistor, R3 is the resistance of the third resistor, Vdd is a voltage level of a voltage supply, and Nmax is an integer equal to a number of voltage divisions between a minimum voltage and a maximum voltage.

The adjusting step preferably includes a step of fine adjusting and a step of coarse adjusting. The digital reference voltage preferably includes a coarse digital reference voltage and a fine coarse digital reference voltage. The output voltage preferably satisfies the following equation:

Vout=k1×Vref−(k2×Nadjc+k3×Nadjf)

where Vout is the output voltage, Nadjc is an integer selected during the coarse adjusting step, Nadjf is an integer selected during the fine adjusting step, and k1, k2, and k3 are constants. The voltage output is preferably connected to a voltage divider with a first resistor and a second resistor connected in series between ground and the output voltage. The second analog reference voltage is preferably connected to a node between the first resistor and the second resistor through a third resistor. The coarse digital reference voltage is preferably connected to a first RC filter including a fourth resistor. The fine digital reference voltage is preferably connected to a second RC filter including a fifth resistor. The constants k1, k2, and k3 preferably satisfy the following equations:

$$k 1 = \frac{R 1 \times R 2 + R 1 \times R 3 + R 2 \times R 3}{R 2 \times R 3}$$

$$k 2 = \frac{Rf}{Rf + Rc} \times \frac{R 1}{R 2} \times \frac{Vddc}{N max c}$$

$$k 3 = \frac{Rc}{Rf + Rc} \times \frac{R 1}{R 2} \times \frac{Vddf}{N max f}$$

where R1 is the resistance of the first resistor, R2 is the resistance of the second resistor, R3 is the resistance of the third resistor, Rc is the resistance of the fourth resistor, Rf is the resistance of the fifth resistor, Vddc is a voltage level of a coarse voltage supply, Vddf is a voltage level of a fine voltage supply, Nmaxc is an integer equal to a number of voltage divisions between a minimum coarse voltage and a maximum coarse voltage, and Nmaxf is an integer equal to a number of voltage divisions between a minimum fine voltage and a maximum fine voltage.

A power system according to a further preferred embodiment of the present invention includes a module arranged to provide an output voltage and a control circuit connected to the module including a manually-adjustable reference voltage circuit arranged to convert an adjustable digital reference voltage to an adjustable analog reference voltage and including an error amplifier arranged to compare the output voltage and the adjustable analog reference voltage and to provide a control signal to the module based upon the comparison of the output voltage and the adjustable analog reference voltage. The control circuit and the module are arranged such that an increase in the adjustable digital reference voltage causes a corresponding increase in the output voltage and a decrease in the adjustable digital reference voltage causes a corresponding decrease in the output voltage.

The power system preferably includes a first push-button connected to the manually-adjustable reference voltage circuit that, when manually activated, increases the adjustable digital reference voltage, and a second push-button connected to the manually-adjustable reference voltage circuit that, when manually activated, decreases the adjustable digital reference voltage.

The manually-adjustable reference voltage circuit preferably includes a microcontroller including a non-volatile memory arranged to store a value corresponding to the adjustable digital reference voltage and including a digital pulse width modulator arranged to output the adjustable digital reference voltage and a low-pass filter arranged to received the adjustable digital reference voltage from the digital pulse width modulator and arranged to output the adjustable analog reference voltage.

The adjustable digital reference voltage preferably includes a coarse adjustable digital reference voltage and a fine adjustable fine digital reference voltage. The manually-adjustable reference voltage circuit preferably includes a microcontroller including a non-volatile memory arranged to store a value corresponding to the adjustable digital reference voltage, including a first digital pulse width modulator arranged to output the coarse adjustable digital reference voltage, and including a second digital pulse width modulator arranged to output the fine adjustable digital reference voltage and includes a low-pass filter arranged to receive the coarse adjustable digital reference voltage from the first digital pulse width modulator, to receive the fine adjustable digital reference voltage from the second digital pulse width modulator, and to output the adjustable analog reference voltage.

The power system preferably further includes a voltage divider connected between the output voltage and ground and including a first resistor and a second resistor. The error amplifier is preferably connected to the output voltage through a node between the first resistor and the second resistor.

A power system according to yet another preferred embodiment of the present invention includes a module arranged to provide an output voltage and a control circuit connected to the module including a fixed reference voltage circuit arranged to provide a fixed analog reference voltage, including a manually-adjustable reference voltage circuit arranged to convert an adjustable digital reference voltage to an adjustable analog reference voltage, and including an error amplifier arranged to compare the fixed analog reference voltage and a combination of the output voltage and the adjustable analog reference voltage and to provide a control signal to the module based upon the comparison of the fixed analog reference voltage and the combination of the output voltage and the adjustable analog reference voltage. The control circuit and the module are arranged such that an increase in the adjustable digital reference voltage causes a corresponding decrease in the output voltage and a decrease in the adjustable digital reference voltage causes a corresponding increase in the output voltage.

The power system preferably further includes a first push-button connected to the manually-adjustable reference voltage circuit that, when manually activated, increases the adjustable digital reference voltage, and a second push-button connected to the manually-adjustable reference voltage circuit that, when manually activated, decreases the adjustable digital reference voltage.

The manually-adjustable reference voltage circuit preferably includes a microcontroller including a non-volatile memory arranged to store a value corresponding to the adjustable digital reference voltage and including a digital pulse width modulator arranged to output the adjustable digital reference voltage and includes a low-pass filter arranged to received the adjustable digital reference voltage from the digital pulse width modulator and arranged to output the adjustable analog reference voltage.

The adjustable digital reference voltage preferably includes a coarse adjustable digital reference voltage and a fine adjustable fine digital reference voltage. The manually-adjustable reference voltage circuit preferably includes a microcontroller including a non-volatile memory arranged to store a value corresponding to the adjustable digital reference voltage, including a first digital pulse width modulator arranged to output the coarse adjustable digital reference voltage, and including a second digital pulse width modulator arranged to output the fine adjustable digital reference voltage and includes a low-pass filter arranged to receive the coarse adjustable digital reference voltage from the first digital pulse width modulator, to receive the fine adjustable digital reference voltage from the second digital pulse width modulator, and to output the adjustable analog reference voltage.

The power system preferably further includes a voltage divider connected between the output voltage and ground and including a first resistor and a second resistor and includes a third resistor connected to a node between the first resistor and the second resistor and connected to the adjustable analog reference voltage. The error amplifier is preferably connected to the output voltage through the node between the first resistor and the second resistor.

Other features, elements, characteristics, arrangements, steps, and advantages of the present invention will become more apparent from the following detailed description of preferred embodiments of the present invention with reference to the attached drawings.

### BRIEF DESCRIPTION OF THE DRAWINGS

FIG. 1 is a circuit diagram of a control system according to a first preferred embodiment of the present invention.

FIG. 2 is a circuit diagram of a control system according to a second preferred embodiment of the present invention.

FIG. 3 is a circuit diagram of a control system according to a third preferred embodiment of the present invention.

FIG. 4 is a circuit diagram of a portion of the control circuit of the control system according to the third preferred embodiment of the present invention.

### DETAILED DESCRIPTION OF PREFERRED EMBODIMENTS

The preferred embodiments of the present invention are discussed below with respect to the figures. These preferred embodiments provide output voltage control methods and circuits that have high set point accuracy with minimal voltage drift. These preferred embodiments provide output voltage control methods and circuits that can be used for both manual adjustments and automatic adjustments that are performed, for example, during factory calibration.

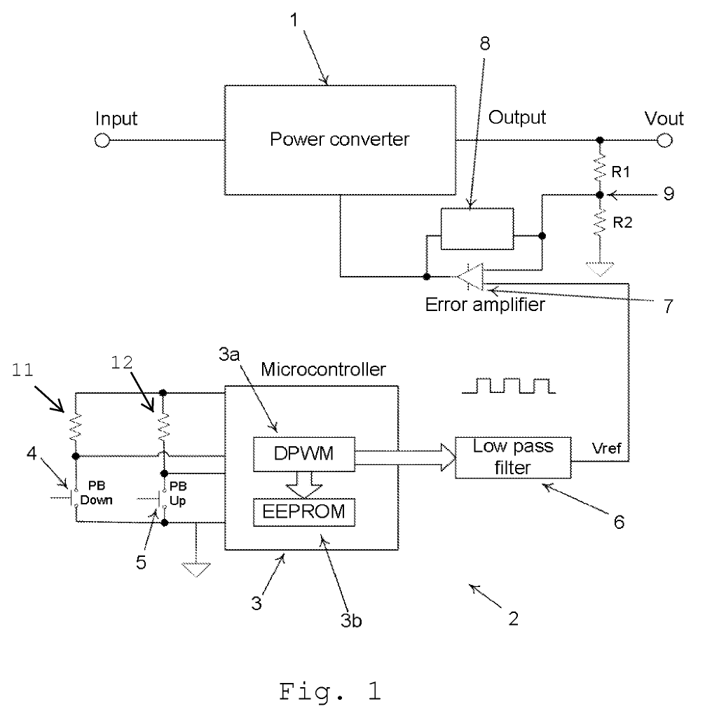

FIG. 1 shows a circuit diagram of the control system according to a first preferred embodiment of the present invention. The control system according to the first preferred embodiment of the present invention includes a control circuit 2 connected to a modular power converter 1. The power converter 1 receives an input and a control signal and provides an output voltage. The control signal controls the voltage level of the output voltage. While FIG. 1 only shows one power converter 1, an array of power converters 1 could also be used. The power converter 1 can be, for example, an AC/DC converter, a DC/DC converter, a point-of-load module, or any other desirable module.

A control circuit 2 outputs the control signal to the individual power module 1. The control circuit 2 preferably includes a down button 4, an up button 5, a microcontroller 3, a low-pass filter 6, a voltage divider 9, an error amplifier 7, and a compensation circuit 8.

The microcontroller 3 preferably includes memory 3b and a DPWM 3a (Digital Pulse Width Modulator). The memory 3b is preferably non-volatile, for example, an EEPROM. However, any desirable memory could be used. The microcontroller 3 senses the state of the down button 4 and the up button 5. Push buttons are preferably used for the down button 4 and the up button 5. However, relays, transistors, or other suitable switching devices can also be used as the down button 4 and the up button 5. As shown in FIG. 1, pull-up resistors 11, 12 are preferably connected to the down button 4 and the up button 5, respectively. Pull-up resistors 11, 12 pull the input to the microcontroller 3 to a high level, and the down button 4 and the up button 5 pull the input the microcontroller 3 to a low level, typically ground.

The microcontroller 3 includes a counter (not shown). When the microcontroller 3 senses the closing of the up button 5, the counter is increased. When the microcontroller 3 senses the closing of the down button 4, the counter is decreased. After the down button 4 or the up button 5 is released back to an open state, the counter then sets a value corresponding to a desired output voltage in a digital format. The value of the counter determines the pulse width of the PWM (pulse width modulated) signal output by the DPWM 3a. For example, a low value of the counter provides a PWM signal with a smaller pulse width, and a high value of the counter provides a PWM signal with a larger pulse width. The microcontroller 3 includes a voltage supply whose voltage level Vdd determines the maximum voltage level of the PWM signal.

More specifically, the counter can preferably be toggled between zero and Nmax. Preferably, the counter preferably is an 8-bit counter in which Nmax equals 255, for example. However, Nmax can be any integer. The buttons 4, 5 are used to pick an integer Nadj, where 0≦Nadj≦Nmax. The integer Nadj, corresponding to the desired voltage, is then be digitally stored in the memory 3b, which allows the same desired voltage to be provided when the microcontroller is powered on. The PWM signal output from the DPWM 3a is a square wave whose maximum voltage level is Vdd and whose on/off-time ratio is Nadj/Nmax.

The microcontroller 3 preferably provides the PWM signal to the low-pass filter 6. It is possible to use any suitable digital-to-analog converter instead of the combination of the DPWM 3a and the low-pass filter 6. The low-pass filter 6 outputs a reference voltage Vref, which is pure DC or DC with some small ripple component, corresponding to the desired voltage level. Thus, the push-buttons 4, 5 can be used to adjust the reference voltage Vref. Preferably, for example, if the low-pass filter 6 is an RC filter, then Vref satisfies the following formula:

$$Vref = Vdd \times \frac{Nadj}{N max}$$

The reference voltage Vref is input into the error amplifier 7. The error amplifier 7 is preferably an operational amplifier (op-amp), for example. The error amplifier 7 compares the reference voltage Vref with a divided voltage. The divided voltage is the voltage received from the voltage divider 9 connected to the output voltage Vout of the power converter 1. The voltage divider 9 includes first resistor R1 and second resistor R2 connected in series between the output voltage Vout of the power converter 1 and ground. The divided voltage is received from a node between the first resistor R1 and second resistor R2. The ratio of the divided voltage and the output voltage Vout is determined by the resistance values of the first and second resistors R1, R2.

The error amplifier 7 provides the control signal based upon the comparison of the reference voltage Vref with the divided voltage. Compensation circuit 8 is preferably connected to the input of the error amplifier 7 receiving the divided voltage and connected to the output of the error amplifier 7 providing the control signal. Compensation circuit 8 shapes the control signal to stabilize the control of the output voltage Vout. It is possible not to use the compensation circuit 8. However, control of the output voltage Vout might be more unstable. The power converter 1 uses the control signal from the error amplifier 7 to control the output voltage Vout. For example, if the power converter 1 is a switching regulator, then the power converter 1 can control the duty ratio of the power converter 1 to control the average output voltage Vout of the power converter 1. It is also possible to use other control techniques, e.g. if the power converter 1 is a linear regulator, to provide the output voltage Vout. Accordingly, with the arrangement shown in FIG. 1, the power converter 1 controls the output voltage Vout in accordance with the following formula:

$$Vout = Vref \times \frac{( R 1 + R 2 )}{R 2} = Vdd \times \frac{Nadj}{N max} \times \frac{( R 1 + R 2 )}{R 2}$$

Because manually toggling the down button 4 and the up button 5 adjusts the reference voltage Vref, the output voltage Vout is manually adjusted. It is also possible to automate this adjust, for example, in a factory, by providing an automation circuit (not shown) that measures the output voltage Vout of the power converter 1 and that compares the output voltage Vout with the desired settings of the power converter 1. If the output voltage Vout is higher than the desired settings, then the automation circuit activates the down button 4. If the output voltage Vout is lower than the desired settings, then the automation circuit activates the up button 5.

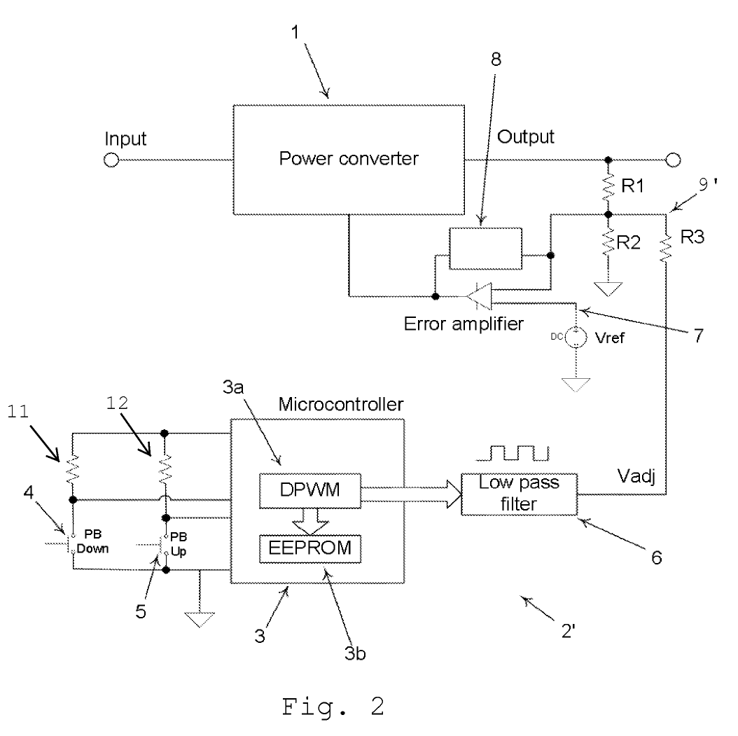

FIG. 2 shows a circuit diagram of the control system according to a second preferred embodiment of the present invention. The control system according to the second preferred embodiment is similar to control system of the first preferred embodiment in that output voltage Vout of the power converter 1 can be manually adjusted. However, the control system according to the second preferred embodiment is different from the control system of the first preferred embodiment in that it does not provide a manually adjustable reference voltage Vref, but instead manually adjusts the divided voltage.

The control system according to the second preferred embodiment of the present invention includes a control circuit 2′ connected to a modular power converter 1. A control circuit 2′ outputs the control signal to the individual power module 1. The control circuit 2′ preferably includes a down button 4, an up button 5, a microcontroller 3, a low-pass filter 6, a voltage divider 9′, an error amplifier 7, and a compensation circuit 8. Because the power converter 1, the down button 4, the up button 5, the microcontroller 3, the low-pass filter 6, the error amplifier 7, and the compensation circuit 8 of the second preferred embodiment are similarly arranged as the similarly numbered elements are arranged in the first preferred embodiment, discussions of these elements is omitted. The voltage divider 9′ includes the series connected first and second resistors R1, R2 connected between the output voltage Vout and ground, as with the voltage divider 9 of the first preferred embodiment, and includes a third resistor R3 connected between a node located between the first and second resistors R1, R2 and the low-pass filter 6.

As the push-buttons 4, 5 of the first preferred embodiment can be used to manually adjust the reference voltage Vref, the push-buttons 4, 5 of the second preferred embodiment can be used to manually adjust the adjustable voltage Vadj. Instead of providing the adjustable voltage Vadj to the error amplifier 7 as the reference voltage Vref is provided in the first preferred embodiment, the adjustable voltage Vadj is connected to the node between the first and second resistors R1, R2 through the third resistor R3.

The error amplifier 7 compares the adjustable voltage Vadj with a fixed reference voltage Vref. The error amplifier 7 provides the control signal based upon the comparison of the reference voltage Vref with the divided voltage. Compensation circuit 8 is preferably connected to the input of the error amplifier 7 receiving the divided voltage and connected to the output of the error amplifier 7 providing the control signal. Compensation circuit 8 shapes the control signal to stabilize the control of the output voltage Vout. It is possible not to use the compensation circuit 8. However, control of the output voltage Vout might be more unstable.

The value of the counter determines the pulse width of the PWM (pulse width modulated) signal output by the DPWM 3a. For example, a low value of the counter provides a PWM signal with a smaller pulse width, and a high value of the counter provides a PWM signal with a larger pulse width. The microcontroller 3 includes a voltage supply whose voltage level Vdd determines the maximum voltage level of the PWM signal.

More specifically, the counter can preferably be toggled between zero and Nmax. Preferably, the counter preferably is an 8-bit counter in which Nmax equals 255, for example. However, Nmax can be any integer. The buttons 4, 5 are used to pick an integer Nadj, where 0≦Nadj≦Nmax. The integer Nadj, corresponding to the desired voltage, is then be digitally stored in the memory 3b, which allows the same desired voltage to be provided when the microcontroller is powered on. The PWM signal output from the DPWM 3a is a square wave whose maximum voltage level is Vdd and whose on/off-time ratio is Nadj/Nmax. Preferably, for example, if the low-pass filter 6 is an RC filter, then Vadj satisfies the following formula:

$$Vadj = Vdd \times \frac{Nadj}{N max}$$

Accordingly, with the arrangement shown in FIG. 2, the power converter 1 controls the output voltage Vout in accordance with the following formula:

$$Vout = Vref \times \frac{R 1 \times R 2 + R 1 \times R 3 + R 2 \times R 3}{R 2 \times R 3} - Vadj \times \frac{R 1}{R 2}$$

$$Vout = Vref \times \frac{R 1 \times R 2 + R 1 \times R 3 + R 2 \times R 3}{R 2 \times R 3} - Vdd \times \frac{Nadj}{N max} \times \frac{R 1}{R 2}$$

Because manually toggling the down button 4 and the up button 5 adjusts the adjustable voltage Vadj, the output voltage Vout is manually adjusted. It is also possible to automate this adjust, for example, in a factory, by providing a automation circuit (not shown) that measures the output voltage Vout of the power converter 1 and that compares the output voltage Vout with the desired settings of the power converter 1. If the output voltage Vout is higher than the desired settings, then the automation circuit activates the down button 4. If the output voltage Vout is lower than the desired settings, then the automation circuit activates the up button 5.

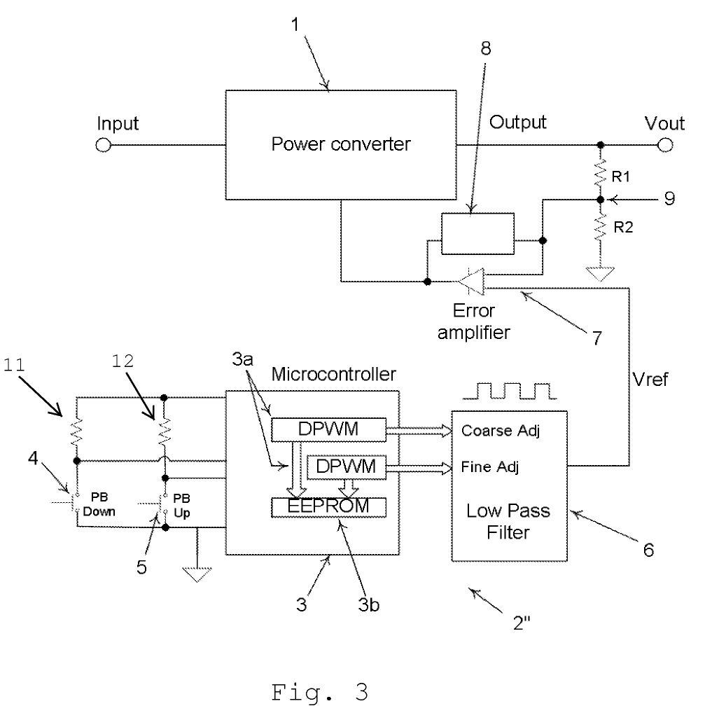

FIG. 3 shows a circuit diagram of a control system according to a third preferred embodiment of the present invention. The control system according to the third preferred embodiment is similar to control system of the first and second preferred embodiments in that output voltage Vout of the power converter 1 can be manually adjusted. However, the control system according to the third preferred embodiment is different from the control system of the first preferred embodiment in that it includes two DPWMs 3a. This arrangement of using two DPWMs 3a can also be included in the control circuit 2′ show in FIG. 2.

Using two DPWMs 3a increases the adjustment resolution of the control system. For example, in the first and second preferred embodiments of the present invention, the counter is preferably an 8-bit counter that can be toggled between zero and 255. One way to increase the resolution is to use a 9-bit counter that can be toggled between zero and 511. However, one of the problems with this approach is that, because the frequency of the DPWM is halved, a larger capacitor must be used in the low-pass filter. This might not be a problem is applications in which size is not important, but this can be a serious issue in applications in which a small size is highly desirable.

Having two DPWMs 3a enables the buttons 4, 5 to have two modes: fine and coarse. For example, holding the pushbutton down for more than about 3 seconds switches the control system from the fine mode to the coarse mode. The microcontroller 3 includes two counters (not shown), each connected to one of the DPWMs 3a. When the microcontroller 3 senses the closing of the up button 5, the fine counter is increased and then the coarse counter is increased if the up button 5 is held down long enough. When the microcontroller 3 senses the closing of the down button 4, the fine counter is decreased and then the coarse counter is decreased if the down button 4 is held down long enough. After the down button 4 or the up button 5 is released back to an open state, the corresponding counter then sets a value corresponding to a desired output voltage in a digital format. The value of the counters determines the pulse widths of the PWM signals output by the DPWMs 3a. For example, a low value of the counters provides a PWM signal with a smaller pulse width, and a high value of the counters provides a PWM signal with a larger pulse width. The microcontroller 3 preferably includes a voltage supply whose voltage level Vdd determines the maximum voltage level of the PWM signals generated by the two DPWMs 3a. Of course, it is possible to use two voltage supplies so that the PWM signals of each of the two DPWMs 3a have a different voltage level Vddc, Vddf.

More specifically, the fine counter can preferably be toggled between zero and Nmax1, and the coarse counter can preferably be toggled between zero and Nmax2. Preferably, the counters preferably are 8-bit counters in which Nmaxc, Nmaxf equals 255, for example. However, Nmaxc, Nmaxf can be any integer. The buttons 4, 5 are used to pick integers Nadjc, where 0≦Nadjc≦Nmaxc, and Nadjf, where 0≦Nadjf≦Nmaxf. The integers Nadjc, Nadjf, corresponding to the desired voltage, are then digitally stored in the memory 3b, which allows the same desired voltage to be provided when the microcontroller is powered on. The PWM signal output from the coarse DPWM 3a is a square waves whose maximum voltage level is Vdd (or Vddc) and whose on/off-time ratio is Nadjc/Nmaxc, and the PWM signal output from the fine DPWM 3a is a square waves whose maximum voltage level is Vdd (or Vddf) and whose on/off-time ratio is Nadjf/Nmaxf.

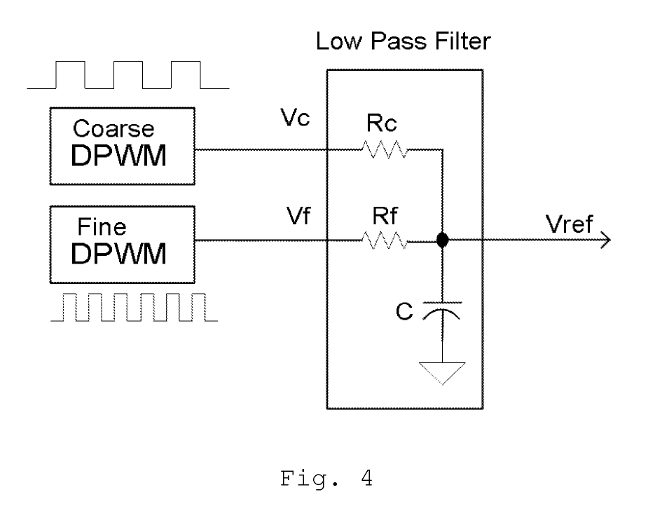

The microcontroller 3 preferably provides the PWM signals to the low-pass filter 6. The low pass filter preferably includes an RC (Resistor-Capacitor) filter network as shown in FIG. 4. The low pass filter 6 preferably includes two RC filter, each of which includes resistors Rc, Rf, respectively and that share a common capacitor C. Preferably, the resistance of resistor Rc is at least about 100 times larger than resistance of resistor Rf, but other suitable relationships between the resistors Rc, Rf can also be used. It is possible to use other suitable configurations, including other configurations of RC filters and configurations that do not use RC filters. It is possible to use any suitable digital-to-analog converter instead of the combination of the DPWM 3a and the low-pass filter 6. The low-pass filter 6 outputs a reference voltage Vref, which is pure DC or DC with some small ripple component, corresponding to the desired voltage level. Thus, the push-buttons 4, 5 can be used to adjust the reference voltage Vref. Preferably, for example, if the low-pass filter 6 is an RC filter, then the following formulas are true:

$$Vc = Vddc \times \frac{Nadjc}{N max c}$$

$$Vf = Vddf \times \frac{Nadjf}{N max f}$$

$$Vref = \frac{1}{Rf + Rc} ( Vc \times Rf + Vf \times Rc )$$

$$Vref = \frac{1}{Rf + Rc} ( Vddc \times \frac{Nadjc}{N max c} \times Rf + Vddf \times \frac{Nadjf}{N max f} \times Rc )$$

Accordingly, with the arrangement shown in FIGS. 3 and 4, the power converter 1 can control the output voltage Vout in accordance with the following formulas:

$$Vout = \frac{R 1 + R 2}{R 2} \frac{1}{Rf + Rc} ( Vc \times Rf + Vf \times Rc )$$

$$Vout = \frac{R 1 + R 2}{R 2} \frac{1}{Rf + Rc} ( \begin{matrix}Vddc \times \frac{Nadjc}{N max c} \times Rf + \\ Vddf \times \frac{Nadjf}{N max f} \times Rc\end{matrix} )$$

If the two DPWMs 3a arrangement shown in FIGS. 3 and 4 is used in the control system according to the second preferred embodiment shown in FIG. 2, then the power converter 1 can control the output voltage Vout in accordance with the following formula:

$$Vout = Vref \times \frac{\begin{matrix}R 1 \times R 2 + R 1 \times \\ R 3 + R 2 \times R 3\end{matrix}}{R 2 \times R 3} - \frac{1}{Rf + Rc} \times \frac{R 1}{R 2} ( \begin{matrix}Vddc \times \frac{Nadjc}{N max c} \times Rf + \\ Vddf \times \frac{Nadjf}{N max f} \times Rc\end{matrix} )$$

Accordingly, by using the preferred embodiments of the present invention, it is possible to provide voltage output control methods and circuits that have high set point accuracy with minimal voltage drift. Further, because these preferred embodiments do not use mechanical contacts, these preferred embodiments do not experience the reliability problems that are present in mechanical potentiometers. These preferred embodiments provide an adjustment system that could be used for both manual adjustments and automatic adjustments performed, for example, during factory calibration.

While the preferred embodiments of the present invention are described as being useful in adjusting the voltage output of the power converter 1, the preferred embodiments could be used for over-voltage or over-current protection systems. The preferred embodiments of the present invention could also be used in point-of-load or isolated DC/DC power supplies, such as brick-type power supplies.

It should be understood that the foregoing description is only illustrative of the present invention. Various alternatives and modifications can be devised by those skilled in the art without departing from the present invention. Accordingly, the present invention is intended to embrace all such alternatives, modifications, and variances that fall within the scope of the appended claims.

What is claimed is:

1. A method of adjusting an output voltage of a module comprising:
providing a digital reference voltage;
converting the digital reference voltage to an analog reference voltage;
comparing the output voltage and the analog reference voltage;
controlling the module based upon a result of the step of comparing the output voltage and the analog reference voltage such that the output voltage corresponds to the analog reference voltage; and
adjusting the digital reference voltage; wherein
an increase in the digital reference voltage causes a corresponding increase in the output voltage; and
a decrease in the digital reference voltage causes a corresponding decrease in the output voltage.

2. A method according to claim 1, wherein the output voltage satisfies the following equation:
Vout=k×Nadj
where Vout is the output voltage, Nadj is an integer selected during the adjusting step, and k is a constant.

3. A method according to claim 2, wherein the voltage output is connected to a voltage divider with a first resistor and a second resistor; and
the constant k satisfies the following equation:
$$k = \frac{R 1 + R 2}{R 2} \times \frac{Vdd}{N max}$$
where R1 is the resistance of the first resistor, R2 is the resistance of the second resistor, Vdd is a voltage level of a voltage supply, and Nmax is an integer equal to a number of voltage divisions between a minimum voltage and a maximum voltage.

4. A method according to claim 1, wherein the adjusting step includes a step of fine adjusting and a step of coarse adjusting;
the digital reference voltage includes a coarse digital reference voltage and a fine coarse digital reference voltage;
the output voltage satisfies the following equation:
Vout=k1×Nadjc+k2×Nadjf
where Vout is the output voltage, Nadjc is an integer selected during the coarse adjusting step, Nadjf is an integer selected during the fine adjusting step, and k1, k2 are constants.

5. A method according to claim 4, wherein the voltage output is connected to a voltage divider with a first resistor and a second resistor;
the coarse digital reference voltage is connected to a first RC filter including a third resistor;
the fine digital reference voltage is connected to a second RC filter including a fourth resistor; and
the constants k1 and k2 satisfy the following equations:
$$k 1 = \frac{R 1 + R 2}{R 2} \times \frac{Rf}{Rf + Rc} \times \frac{Vddc}{N max c}$$
$$k 2 = \frac{R 1 + R 2}{R 2} \times \frac{Rc}{Rf + Rc} \times \frac{Vddf}{N max f}$$
where R1 is the resistance of the first resistor, R2 is the resistance of the second resistor, Rc is the resistance of the third resistor, Rf is the resistance of the fourth resistor, Vddc is a voltage level of a coarse voltage supply, Vddf is a voltage level of a fine voltage supply, Nmaxc is an integer equal to a number of voltage divisions between a minimum coarse voltage and a maximum coarse voltage, and Nmaxf is an integer equal to a number of voltage divisions between a minimum fine voltage and a maximum fine voltage.

6. A method of adjusting an output voltage of a module comprising:
providing a digital reference voltage and a first analog reference voltage;
converting the digital reference voltage to a second analog reference voltage;
combining the second analog reference voltage and the output voltage;
comparing the first analog reference voltage and the combined second analog reference voltage and output voltage;
controlling the module based upon a result of the step of comparing the first analog reference voltage and the combined second analog reference voltage and output voltage so the output voltage corresponds to the second analog reference voltage;
adjusting the digital reference voltage; wherein
an increase in the digital reference voltage causes a corresponding decrease in the output voltage; and
a decrease in the digital reference voltage causes a corresponding increase in the output voltage.

7. A method according to claim 6, wherein the output voltage satisfies the following equation:
Vout=k1×Vref−k2×Nadj
where Vout is the output voltage, Vref is the first analog reference voltage, Nadj is an integer selected during the adjusting step, and k1 and k2 are constants.

8. A method according to claim 7, wherein the voltage output is connected to a voltage divider with a first resistor and a second resistor connected in series between ground and the output voltage;
the second analog reference voltage is connected to a node between the first resistor and the second resistor through a third resistor; and
the constants k1 and k2 satisfy the following equations:
$$k 1 = \frac{R 1 \times R 2 + R 1 \times R 3 + R 2 \times R 3}{R 2 \times R 3}$$
$$k 2 = \frac{R 1}{R 2} \times \frac{Vdd}{N max}$$
where R1 is the resistance of the first resistor, R2 is the resistance of the second resistor, R3 is the resistance of the third resistor, Vdd is a voltage level of a voltage supply, and Nmax is an integer equal to a number of voltage divisions between a minimum voltage and a maximum voltage.

9. A method according to claim 6, wherein the adjusting step includes a step of fine adjusting and a step of coarse adjusting;
the digital reference voltage includes a coarse digital reference voltage and a fine coarse digital reference voltage; and
the output voltage satisfies the following equation:
Vout=k1×Vref−(k2×Nadjc+k3×Nadjf)
where Vout is the output voltage, Nadjc is an integer selected during the coarse adjusting step, Nadjf is an integer selected during the fine adjusting step, and k1, k2, and k3 are constants.

10. A method according to claim 9, wherein the voltage output is connected to a voltage divider with a first resistor and a second resistor connected in series between ground and the output voltage;
the second analog reference voltage is connected to a node between the first resistor and the second resistor through a third resistor;
the coarse digital reference voltage is connected to a first RC filter including a fourth resistor;
the fine digital reference voltage is connected to a second RC filter including a fifth resistor; and
the constants k1, k2, and k3 satisfy the following equations:
$$k 1 = \frac{R 1 \times R 2 + R 1 \times R 3 + R 2 \times R 3}{R 2 \times R 3}$$
$$k 2 = \frac{Rf}{Rf + Rc} \times \frac{R 1}{R 2} \times \frac{Vddc}{N max c}$$
$$k 3 = \frac{Rc}{Rf + Rc} \times \frac{R 1}{R 2} \times \frac{Vddf}{N max f}$$
where R1 is the resistance of the first resistor, R2 is the resistance of the second resistor, R3 is the resistance of the third resistor, Rc is the resistance of the fourth resistor, Rf is the resistance of the fifth resistor, Vddc is a voltage level of a coarse voltage supply, Vddf is a voltage level of a fine voltage supply, Nmaxc is an integer equal to a number of voltage divisions between a minimum coarse voltage and a maximum coarse voltage, and Nmaxf is an integer equal to a number of voltage divisions between a minimum fine voltage and a maximum fine voltage.

11. A power system comprising:
a module arranged to provide an output voltage; and
a control circuit connected to the module including:
a manually-adjustable reference voltage circuit arranged to convert an adjustable digital reference voltage to an adjustable analog reference voltage; and
an error amplifier arranged to compare the output voltage and the adjustable analog reference voltage and to provide a control signal to the module based upon the comparison of the output voltage and the adjustable analog reference voltage; wherein the control circuit and the module are arranged such that:
an increase in the adjustable digital reference voltage causes a corresponding increase in the output voltage; and
a decrease in the adjustable digital reference voltage causes a corresponding decrease in the output voltage.

12. A power system according to claim 11, further comprising:
a first push-button connected to the manually-adjustable reference voltage circuit that, when manually activated, increases the adjustable digital reference voltage; and
a second push-button connected to the manually-adjustable reference voltage circuit that, when manually activated, decreases the adjustable digital reference voltage.

13. A power system according to claim 11, wherein the manually-adjustable reference voltage circuit includes:
a microcontroller including:
a non-volatile memory arranged to store a value corresponding to the adjustable digital reference voltage; and
a digital pulse width modulator arranged to output the adjustable digital reference voltage; and
a low-pass filter is arranged to receive the adjustable digital reference voltage from the digital pulse width modulator and arranged to output the adjustable analog reference voltage.

14. A power system according to claim 11, wherein the adjustable digital reference voltage includes a coarse adjustable digital reference voltage and a fine adjustable fine digital reference voltage;
the manually-adjustable reference voltage circuit includes:
a microcontroller including:
a non-volatile memory arranged to store a value corresponding to the adjustable digital reference voltage;
a first digital pulse width modulator arranged to output the coarse adjustable digital reference voltage; and
a second digital pulse width modulator arranged to output the fine adjustable digital reference voltage; and
a low-pass filter is arranged to receive the coarse adjustable digital reference voltage from the first digital pulse width modulator, to receive the fine adjustable digital reference voltage from the second digital pulse width modulator, and to output the adjustable analog reference voltage.

15. A power system according to claim 11, further comprising a voltage divider connected between the output voltage and ground and including a first resistor and a second resistor; wherein
the error amplifier is connected to the output voltage through a node between the first resistor and the second resistor.

16. A power system comprising:
a module arranged to provide an output voltage; and
a control circuit connected to the module including:
a fixed reference voltage circuit arranged to provide a fixed analog reference voltage;
a manually-adjustable reference voltage circuit arranged to convert an adjustable digital reference voltage to an adjustable analog reference voltage; and
an error amplifier arranged to compare the fixed analog reference voltage and a combination of the output voltage and the adjustable analog reference voltage and to provide a control signal to the module based upon the comparison of the fixed analog reference voltage and the combination of the output voltage and the adjustable analog reference voltage; wherein the control circuit and the module are arranged such that:
an increase in the adjustable digital reference voltage causes a corresponding decrease in the output voltage; and
a decrease in the adjustable digital reference voltage causes a corresponding increase in the output voltage.

17. A power system according to claim 16, further comprising:
a first push-button connected to the manually-adjustable reference voltage circuit that, when manually activated, increases the adjustable digital reference voltage; and
a second push-button connected to the manually-adjustable reference voltage circuit that, when manually activated, decreases the adjustable digital reference voltage.

18. A power system according to claim 16, wherein the manually-adjustable reference voltage circuit includes:
a microcontroller including:
a non-volatile memory arranged to store a value corresponding to the adjustable digital reference voltage; and
a digital pulse width modulator arranged to output the adjustable digital reference voltage; and
a low-pass filter arranged to receive the adjustable digital reference voltage from the digital pulse width modulator and arranged to output the adjustable analog reference voltage.

19. A power system according to claim 16, wherein the adjustable digital reference voltage includes a coarse adjustable digital reference voltage and a fine adjustable fine digital reference voltage;
the manually-adjustable reference voltage circuit includes:
a microcontroller including:
a non-volatile memory arranged to store a value corresponding to the adjustable digital reference voltage;
a first digital pulse width modulator arranged to output the coarse adjustable digital reference voltage; and
a second digital pulse width modulator arranged to output the fine adjustable digital reference voltage; and
a low-pass filter is arranged to receive the coarse adjustable digital reference voltage from the first digital pulse width modulator, to receive the fine adjustable digital reference voltage from the second digital pulse width modulator, and to output the adjustable analog reference voltage.

20. A power system according to claim 16, further comprising:
a voltage divider connected between the output voltage and ground and including a first resistor and a second resistor; and
a third resistor connected to a node between the first resistor and the second resistor and connected to the adjustable analog reference voltage; wherein
the error amplifier is connected to the output voltage through the node between the first resistor and the second resistor.
